(19) United States
(12) Patent Application Publication
(10) Pub. No.: US 2019/0268353 A1
(43) Pub. Date: Aug. 29, 2019

(54) SYSTEMS AND METHODS FOR PREVENTING MALICIOUS NETWORK TRAFFIC FROM ACCESSING TRUSTED NETWORK RESOURCES

(71) Applicant: ShieldX Networks, Inc., San Jose, CA (US)

(72) Inventors: Ratinder Paul Singh Ahuja, Saratoga, CA (US); Manuel Nedbal, Santa Clara, CA (US); Samir Shah, Santa Clara, CA (US)

(21) Appl. No.: 15/903,499

(22) Filed: Feb. 23, 2018

(51) Int. Cl. H04L 29/06

(52) U.S. Cl. CPC H04L 63/1416; H04L 63/0876; H04L 63/02; H04L 63/20; H04L 63/1425

(57) ABSTRACT

Systems, methods, and apparatuses prevent malicious network traffic from accessing or being transmitted to trusted network resources in a network environment. In one embodiment, a management microservice initializes a security microservice on a computing device and configures a network interface as a secure channel for communications with the security microservice. When the management microservice authenticates the network interface, the management microservice enables a data channel interface for the security microservice, allowing the security microservice to receive network traffic from other security microservices. Prior to enabling the data channel interface, the security microservice does not have an active interface with any other security microservices, which prevents any traffic, including malicious network traffic from reaching areas of the security microservice during the initialization process.

### TECHNICAL FIELD

Embodiments described herein generally relate to network security. In particular, embodiments described herein generally relate to systems and methods for preventing potentially malicious network traffic from accessing trusted network resources in a network environment.

### BACKGROUND INFORMATION

A majority of businesses and other organizations rely on computer systems and networks for an increasingly wide variety of business operations. As reliance on computing technologies has grown, so too has the importance of securing computer systems and networks against internal and external security threats. However, the breadth and complexity of security threats targeting such computer systems and networks is far and wide and ever growing. To monitor and address these security threats, organizations increasingly rely on sophisticated computer security applications and hardware such as firewalls, anti-virus tools, data loss prevention (DLP) software, etc.

### BRIEF DESCRIPTION OF THE DRAWINGS

The various advantages of the embodiments disclosed herein will become apparent to one skilled in the art by reading the following specification and appended claims, and by referencing the drawings, in which:

FIG. 1 is a block diagram of a network security system illustrating computer hardware, including a memory and processor, in accordance with the disclosed embodiments;

FIG. 2 illustrates a scalable security architecture implementing a three-time scale out using security microservices in accordance with the disclosed embodiments;

FIG. 3 illustrates an arbitrary scaling out of a microservice in accordance with the disclosed embodiments;

FIG. 4 is a block diagram illustrating a security service configured to monitor traffic sent among an application and one or more servers through a routing network in accordance with the disclosed embodiments;

FIG. 5 is a block flow diagram illustrating application data traversing to a server after passing through a hierarchy of security microservices in accordance with the disclosed embodiments;

FIG. 6 is a flow of application data through a stateless processing, fault-tolerant microservice environment in accordance with the disclosed embodiments;

FIG. 7 is a block diagram illustrating an example system for using an interface microservice to intercept network traffic routed by a virtual switch (vSwitch);

FIG. 8 is a block diagram illustrating an example interface microservice configured to intercept network traffic routed by a vSwitch in accordance with the disclosed embodiments;

FIG. 9 is a block diagram illustrating an example system for using security microservices to intercept and inspect network traffic in accordance with the disclosed embodiments;

FIG. 10 is a flow diagram illustrating a process for initializing security microservices in a computing device in accordance with an embodiment;

FIG. 11 is a block diagram that illustrates a computer system utilized in implementing the above-described techniques in accordance with some of the disclosed embodiments.

### DETAILED DESCRIPTION

In the following description, numerous specific details are set forth. However, it is understood that embodiments of the disclosure may be practiced without these specific details. In other instances, well-known circuits, structures and techniques have not been shown in detail to not obscure the understanding of this description.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In order to monitor network traffic for potentially bad or malicious network traffic, a security system utilizing a plurality of security microservices can be implemented. In typical systems, the security system can spawn or initialize components (e.g., security microservices) that perform security analyses of the network traffic. However, deficiencies of existing security solutions become apparent from the typical structure of security microservices. For example, while memory allocated to each microservice is generally separate from the memory of other microservices, such that a first microservice security cannot affect the memory for a second microservice, this may not be the case within a single microservice as it is common for all processing aspects of a microservice to share the same memory. For example, a microservice inspecting network traffic for a virtual environment must maintain in its memory the processing code and data structures related to policy enforcement, central communications and flow records as well as the potentially malicious packets and communications being analyzed. This can result in a trusted area of a microservice sharing memory space with an untrusted area of the microservice. Because potentially malicious packets and communications are not sequestered from the other microservice memory components, existing security systems may be unable to sufficiently protect against malicious network traffic reaching trusted areas of the security system.

To address the deficiencies of existing security infrastructures, embodiments detailed herein use a management microservice to efficiently manage the initialization of security microservices tasked with performing analyses on network traffic. To that end, the management microservice configures a management network interface between the security microservice and the management microservice, and authenticates the management microservice interface prior to configuring and enabling components of the security microservice operating in a data channel. By first authenticating the management network interface, the management microservice prevents network traffic, including potentially malicious network traffic, from being received by the security microservice and reaching the management microservice.

For example, some embodiments detailed herein utilize an authentication process as part of the initialization process for security microservices. In some embodiments, a management microservice does not enable a data channel interface between an initializing security microservice and other security microservices in a networked environment. When the data channel interface is not enabled, the initializing security microservice is not able to receive network traffic, including potentially malicious traffic. In such embodiments, the management microservice enables the data channel interface only after the management microservice completes an authentication process with the security microservice during the initialization process.

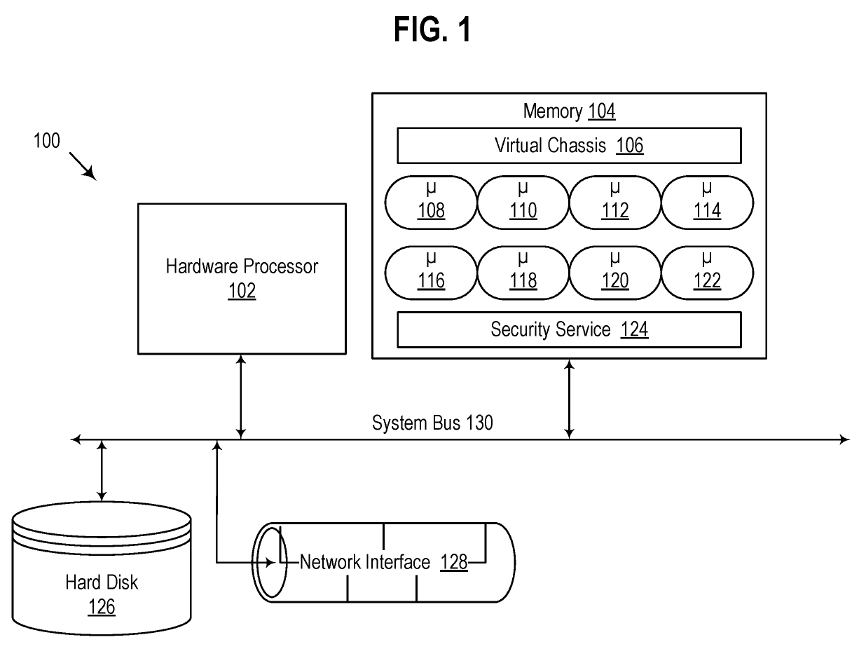

FIG. 1 is a block diagram of a network security system 100 illustrating computer hardware, including a memory (e.g., 104) and processor (e.g., 102), in accordance with the disclosed embodiments. Block diagram 100 further includes a hard disk (e.g., 126) and network interface 128. In one embodiment, hardware processor, memory 104, hard disk 126, and network interface 128 are coupled to each other via a system bus (e.g., 130). Network security microservices 108-122 are stored in memory 104 (e.g., volatile memory such as Random Access Memory (RAM) and/or non-volatile memory such as disk) and executed by one or more hardware processors or processor cores 102. Network security microservices 108-122, consisting of computer-executable instructions to perform one or more specific security services, are deployed based on configuration across available physical servers. Typically, each microservice receives a configuration and tasks via a backplane of a virtual chassis 106, and returns status, statistics, and other information to the backplane.

The data processed by the network security system 100 is transferred from a microservice to another (higher hierarchy) microservice using a data plane. In some embodiments, during such a transfer, a lower microservice decides (based on configuration, current statistics, and other information) as to which next microservice to utilize. Such a decision may constitute a load-balancing decision to assure that the higher-hierarchy microservices are efficiently utilized. In other embodiments, the decision of which microservice to utilize is made by a more central entity.

As illustrated, a network security system 100 utilizes a hardware processor 102 (such as a central processing unit (CPU) or one or more cores thereof, a graphics processing unit (GPU) or one or more cores thereof, or an accelerated processing unit (APU) or one or more cores thereof) to execute microservices and other applications (e.g., virtual chassis 106, security service 124, etc.) stored in memory 104. A network interface 128 (e.g., fabric or interconnect that is wired or wireless) provides a means for communicating with a data center. Network security system 100 may inspect traffic, detect threats, generate security policies (e.g., access control lists), and otherwise protects a data center using the microservices 108-122.

Embodiments of a network security system 100 providing the above capabilities are now discussed in more detail. Network security system 100 adds security to, or enhances the security of, a datacenter or other computing environment. In one embodiment, network security system 100 is delivered (e.g., downloaded) in the form of a seed software application. The seed software application instantiates microservices of the network security system on a host in the datacenter. As used herein, a microservice container refers to where the microservice runs, for example, on a virtual machine. Once deployed, network security system 100 utilizes a hardware processor 102, memory 104, and network interface 128. In many scenarios, security can be added/configured using existing hardware and/or without purchasing additional rack devices for particular functionality. The seed software application may be installed on any one of a wide variety of hosts—be they slow or fast, low-cost or high-cost, commodity or customized, geographically dispersed, part of a redundancy scheme, or part of a system with regular back-ups.

In some embodiments, a network security system 100 utilizes a network interface 128 to explore the datacenter and to discover existing network segments, determine security settings to apply to various network segments, detect available hosts and hardware resources, and determine additional configuration information as needed. In one embodiment, the datacenter itself includes several machines with hypervisors, or physical hardware, and the network security system 100 offers microservices to communicate with and protect one or more of those internal virtual machines or physical hardware. Based on performing datacenter discovery, a network security system 100, in some embodiments, may then offer or suggest available security tools for selection either through a graphical interface or via connections with existing enterprise management software. In one embodiment, once configured, a network security system 100 is deployed “in-line,” receiving packets headed for the datacenter, thereby allowing network security system to intercept and block suspicious traffic before it reaches the datacenter. With an understanding of the datacenter, a network security system 100 deploys microservices to inspect traffic throughout the datacenter, and not only at ingress. In some embodiments, a network security system 100 is deployed in a “copy only” configuration, in which the system monitors traffic, detects threats, and generates alerts, but does not intercept traffic before it arrives at the datacenter.

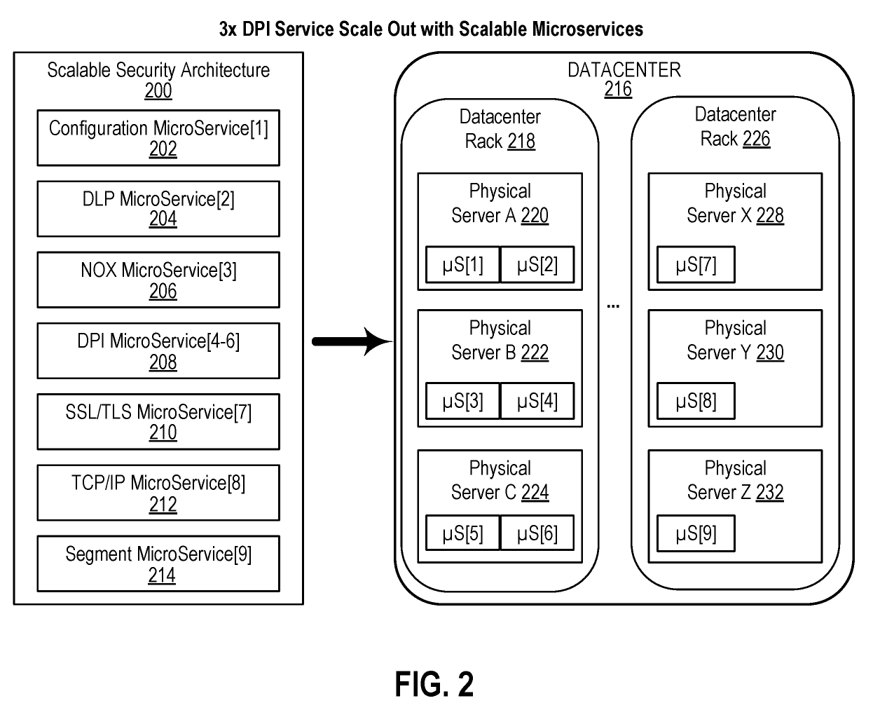

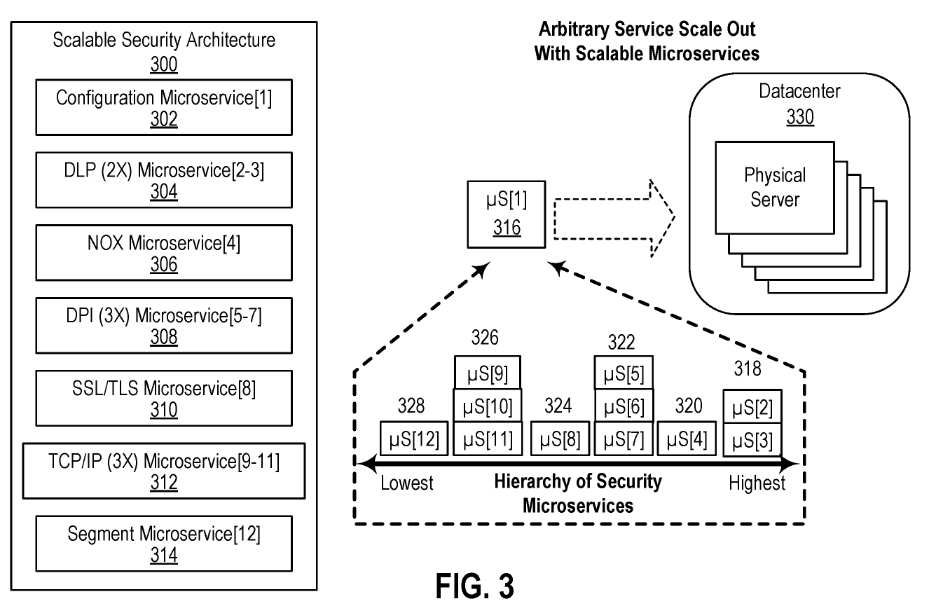

As shown, memory 104 has stored therein microservices 108, 110, 112, 114, 116, 118, 120, and 122 (108-122), as well as a virtual chassis 106, which may also be a microservice. In one embodiment, the microservices are small in size, consisting of a relatively small number of instructions. In one embodiment, the microservices 108-122 are independent of each other. As illustrated, microservices 108-122 are microservices that are loaded from memory and executed by the hardware processor 102. Those microservices 108-122 include data path security microservices, for example TCP/IP, SSL, DPI, or DLP microservices, as described further below with respect to FIGS. 2 and 3. The microservices 108-122 may also include management microservices, for example, a chassis controller to manage the microservices, a configuration microservice, an infrastructure discovery microservice, a database microservice to store data, a policy update microservice to receive policy updates from an external security cloud, and a compiler to receive policy data from various sources and to produce binary policy outputs to be used by the microservices, to name a few examples that are described hereinafter with respect to FIGS. 2 and 3.

Memory 104 also stores security service 124. Security service 124 is configured to utilize a plurality of microservices to manage the initialization of other security microservices on a computing device to prevent potentially bad or malicious network traffic from being transmitted to trusted network resources (e.g., management microservices). In one embodiment, security service 124 prevents network traffic from traversing from a data plane to a control plane by establishing an authenticated interface prior to enabling data channel interfaces. In one embodiment, the embodiments disclosed herein are performed by security service 124. In other embodiments, the embodiments disclosed herein are performed by microservices (e.g., microservices 108-122) based on instructions from security service 124.

It will be understood by those of ordinary skill in the art that a datacenter typically employs many instances of the hardware represented within network security system 100 such as hardware processor 102 and memory 104. Individual servers may have multiple processors or multiple processing boards each with multiple processors. Processors may have a plurality of processing cores and access a plurality of network interfaces. Security service 124 comprises program code executing within a processor and may have interfaces (such as configuration or administration user interfaces) that are made available over a network to users. In a virtualized environment, the user may not be aware of the specific processor on which security service 124 is executing and, in some embodiments, that processor may change based on loading of the virtual environment. Such changes may occur based on administrator requests or automatically based on the virtual environment's control software.

In one embodiment, a network security system 100 receives traffic via network interface 128 to/from a datacenter. In one embodiment, a network security system 100 is placed in-line to inspect traffic, and potentially intercept a threat before it arrives at, or leaves, the datacenter. In other embodiments, a network security system 100 monitors the traffic heading into, or out of, the datacenter, in which case the network security system 100 detects threats and generates alerts, but does not block the data. A hardware processor 102 may execute various data security microservices on the data. For example, as described hereinafter with respect to FIGS. 2 and 3, typically traffic first passes into and through a segment microservice, then a TCP/IP inspection microservice, then a SSL microservice, then a DPI microservice, then a NOX microservice, and then a DLP microservice. However, one or more of these services may not be enabled. In some embodiments, a segment microservice resides within a network segment and serves as the entry point for data packets and forwards the packets to appropriate microservices for further analysis. Data path microservices as used herein refer to various microservices that inspect and analyze network traffic, such as TCP, TLS, DPI, NOX, and DLP microservices. A TCP microservice, for example, refers to a packet handling microservice able to process any layer 4-6 network packet and includes part of firewalling. A TLS microservice, for example, refers to a Transport Layer Security microservice, which decrypts/re-encrypts connections. A DPI microservice, for example, refers to a Deep Packet Inspection microservice and handles layer 7 inspection. A NOX microservice, for example, refers to a Network Object Extractor microservice, and works in conjunction with DPI to assemble objects from individual packets and to deliver the objects to other services. A DLP microservice, for example, refers to a Data Loss Prevention microservice, which detects and attempts to prevent data loss. Control path microservices, on the other hand, are various microservices, such as a factory, a compiler, a configuration, an infrastructure discovery, a database, a messenger, a scaler, and a chassis controller, that are instantiated in, and make up, a management plane. Threats detected by the aforementioned microservices, in one embodiment, are reported to a chassis controller microservice, which takes remedial action.

In one embodiment, microservices 108-122 are implemented using computer-executable instructions loaded from the Internet via network interface 128. For instance, In one embodiment, the microservices are implemented with computer-executable instructions downloaded from a web site or online store site. In some embodiments, microservices 108-122 are loaded into memory 104. In various embodiments, the microservices are implemented using computer-executable instructions loaded on and received from a non-transitory computer-readable medium, such as digital media, including another disc drive, a CD, a CDROM, a DVD, a USB flash drives, a Flash memory, a Secure Digital (SD) memory card, a memory card, without limitation. Microservices received from a digital medium may be stored into memory 104. The embodiments are not limited in this context. In further embodiments, a digital medium is a data source that constitutes a combination of hardware elements such as a processor and memory.

In most embodiments, a network security system 100 runs on a datacenter computer. In other embodiments, however, a network security system 100 is installed and runs on any one of a wide variety of computing platforms, ranging from low-cost to high-cost, and from low-power to high power. In some embodiments, a network security system 100 runs on a server. In some embodiments, a network security system 100 is installed on and runs on a low-cost, commodity server computer, or on a low-cost rack-mounted server. As illustrated, hardware processor 102 is a single core processor. In alternate embodiments, hardware processor 102 is a multi-core processor. In alternate embodiments, hardware processor 102 is a massively parallel processor. In some embodiments, a virtual chassis 106 and microservices 108-122 may be hosted on any of a wide variety of hardware platforms used in the datacenter to be protected.

In some embodiments, a network security system 100 scales out using available resources to accommodate higher traffic or load. In one embodiment, hardware processor 102 (CPU) and memory 104 are scaled out or in dynamically as needed: additional CPUs and memory are added if scaling out, and some CPUs and/or memory are powered down if scaling in. This scaling out is performed to allocate the additional CPUs and memory to those portions of the security hierarchy for which there is demand, while not allocating additional CPUs and memory to those portions of the security hierarchy that can accommodate the higher traffic utilizing their existing allocation.

One property of a microservice is the separation and protection of memory from other microservices. In this manner, an individual microservice may be moved to another physical server or terminate abnormally without impacting other microservices. Microservices may be distinguished from threads in that threads generally operate within a shared memory space and exist within the confines of an operating system on which the microservices were spawned.

FIG. 2 illustrates an example scalable security architecture implementing a three-time scale out using security microservices. In the example of FIG. 2, only a single microservice (e.g., a DPI microservice) has a demand for additional resources. As shown, by utilizing a scalable microservice architecture 200, including DLP microservice 204, NOX microservice 206, DPI microservice 208, SSL/TLS microservice 210, TCP/IP microservice 212, and segment microservice 214, each level of the security service hierarchy can be scaled and configured independently to load balance the supply of processed data to the next hierarchy level. As shown, datacenter 216 includes datacenter rack 218, which includes physical server A 220, physical server B 222, and physical server C 224. As shown, a datacenter rack 226 includes physical server X 228, physical server Y 230, and physical server Z 232. DPI microservices 208 have been scaled out 3X, and in this instance assigned to be performed as microservices 4-to-6 on physical server B 222 and physical server C 224. The remaining microservices of scalable security architecture are shown as being implemented by physical servers A, X, Y, and Z (220, 228, 230, and 232, respectively). A configuration microservice 202 creates a configuration backplane and a data plane deployed as a software component on each physical server that is to receive security services. This process includes configuring routing rules, reserving network address space (such as a subnet), and configuring virtual environments to utilize portions of the reserved address space as gateways for network communication in and out of the servers to be secured. Both the backplane and data plane may thus be considered virtual networks managed by the security system. Security microservices may then utilize these networks to transmit packets, content, state, and other information among the microservices. The properties of the backplane and data plane are configured to reject packet traffic from outside the security system and to route information between microservices regardless of the physical server and virtual environment configuration.

FIG. 3 illustrates an arbitrary scaling out of a microservice according to an embodiment. As shown, scalable security architecture 300 includes configuration microservice 302, DLP (2×) microservice 304 (a 2-times scale-out), NOX microservice 306, DPI (3×) microservice 308 (a 3-times scale-out), SSL/TLS microservice 310, TCP/IP (3×) microservice 312 (a 3-times scale-out), and segment microservice 314. As shown, configuration microservice 316 provisions (318, 320, 322, 324, 326, and 328) the 11 microservices from a lowest hierarchy to a highest hierarchy, and configures them to communicate with each other via a backplane. The microservices, for example, may be implemented by physical servers in datacenter 330.

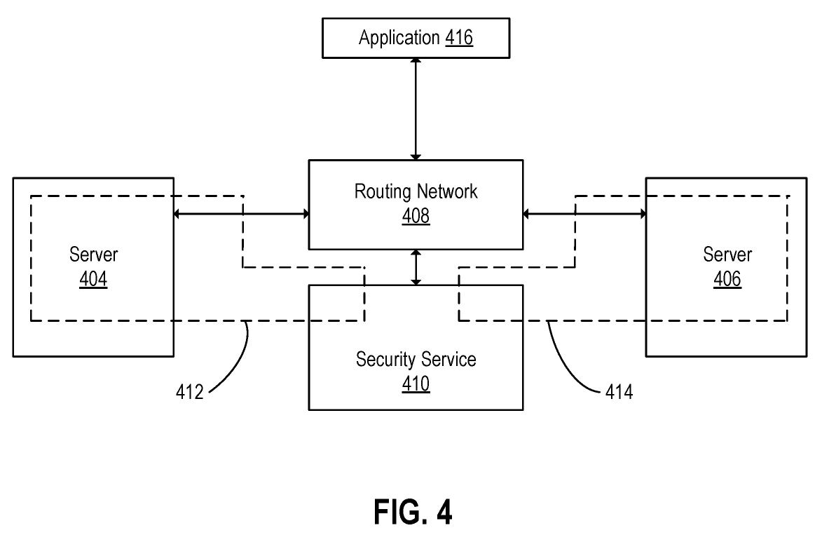

FIG. 4 is a block diagram illustrating a networked computing environment in which an embodiment may be implemented. FIG. 4 represents an example embodiment that is provided for purposes of illustrating a clear example; other embodiments may use different arrangements.

The networked computer system depicted in FIG. 4 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

In one embodiment, one or more security services 410 may be configured to monitor network traffic and other data sent between an application 416 and one or more servers 404, 406 through a routing network 408. In one embodiment, security service 410 is an example of security service 124 in FIG. 1. In one embodiment, security service 410 comprises one or more “microservices” (e.g., microservices 108-122 in FIG. 1) used to monitor and perform various actions relative to data items (e.g. network traffic, files, email messages, etc.) sent to and received from one or more applications 416 and servers 404, 406. The microservices comprising security service 410 do not need to be confined to one physical server such as a server 404, 406. For example, one or more microservices of the security service 410 may be executed on server 404 and other microservices of the security service 410 are executed on 406. In some embodiments, the security service 410 is executed on a different server from one or more servers for which the security service is responsible for monitoring and protecting. In one embodiment, servers 404, 406, security service 410, and application 416 are deployed in a networked environment. Examples of networked environments include data centers, an on-premise stack, and a set of servers remotely connected using a network.

In one embodiment, a routing network 408 provides connectivity among servers 404, 406, security service 410, and application 416. In some embodiments, routing network 408 is partially configured responsive to hypervisor configuration of servers 404 and 406. In some embodiments, a routing network 408 is partially or entirely configured responsive to hypervisor configuration of servers 404 and/or 406.

In one embodiment, based on routing information included in channel data encapsulation packets, data traveling between an application 416 and server 404 and/or server 406 is routed to the correct server, and is kept separate from data traveling between the application 416 and the other server. Accordingly, what is essentially a private network 412 may be created between the server running security service 410 and server 404. Similarly, what is essentially a private network 414 may be created between the server running security service 410 and server 406.

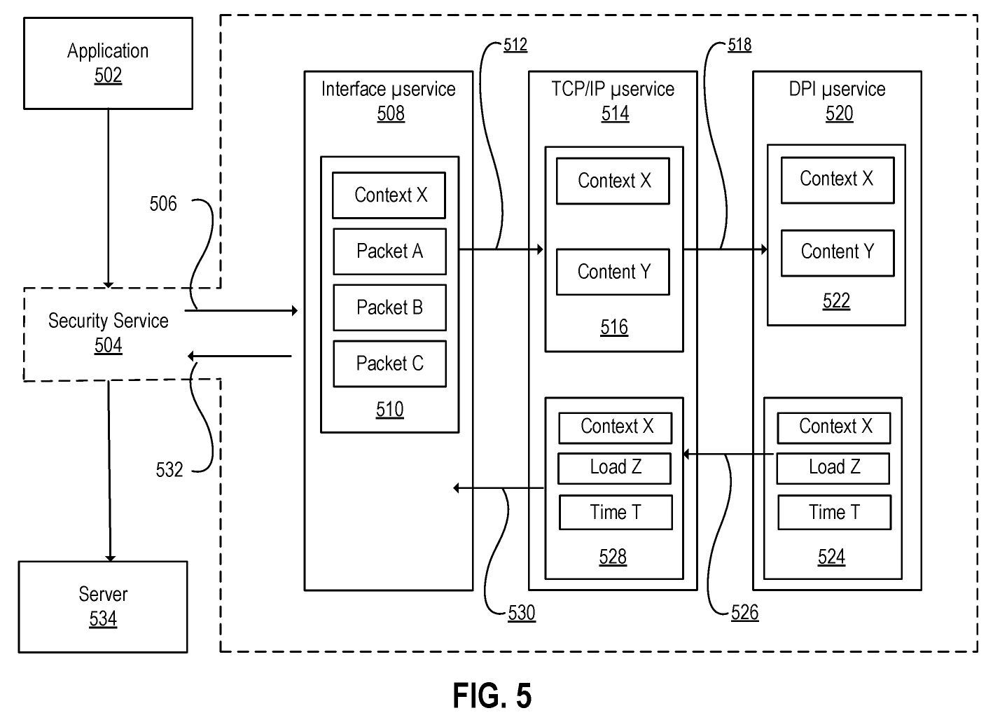

FIG. 5 is a block flow diagram illustrating application data traversing to a server after passing through a hierarchy of security microservices according to an embodiment. As illustrated, the flow begins with security service 504 receiving a network data packet from application 502. Security service 504 forwards 506 the packet to interface microservice 508, which generates a channel data encapsulation packet 510 encapsulating three packets A, B, and C, and a context X. As shown, channel data encapsulation packet 510 encapsulates three packets, but in alternate embodiments, the number of encapsulated packets may vary without limitation. In some embodiments, context X is generated based at least on the headers of packets A, B, and C. In some embodiments, context X is generated based on a lookup of packet header fields such as IP addresses, ports, and MAC addresses for the source and destination of the packets. In some embodiments, the generation of context X includes using an interface identifier obtained from a virtualization environment. Generation of context X may be accomplished through a lookup of header fields and other data in a table, a hash of header fields and other data, or another method whereby packets for which a common security policy is to be applied are associated with a common context or common portion, such as a bit field, of the context.

Context X may be considered an identifier describing the traffic streams, source machines, or applications responsible for generating packets A, B and C. This identifier may be direct (such as an ID used as a table look up), indirect (such as a pointer used to access a data structure), or some other method of instructing microservices as to the policies and processing to use for handling packets A, B, and C. As an example, context X may be generated by performing a hash, longest prefix match, or lookup of header fields such as IP addresses, TCP ports, interface names (or MAC addresses), or other packet properties. The lookup may be an exact match, longest prefix match, or other method to associate packet streams with the same security processing to use. The generated context may then be used by security services, such as a DPI service, to determine which rules to utilize when scanning the data from packets A, B, and C (and other packets that are part of the same traffic stream). This information may be embedded within the context (as a bit field or other information), available by indirection (such as a table or data structure lookup by another service), or generated programmatically based on any combination of such information.

The context may be generated through a look up at an interface microservice and is included in the transmission of packet data to transmission control protocol (TCP) reassembly services. Reassembled content from the TCP microservice is transmitted to a deep packet inspection (DPI) microservice or secure socket layer (SSL) microservice, and with the same context. By maintaining this context in the encapsulation of data transport throughout the microservice hierarchy, processing directives associated with a context become a shared read-only resource (relative to the microservices) and may only rarely use stateful updates.

Interface microservice 508 transmits 512 the channel data encapsulation packet 510 to TCP/IP microservice 514. As shown, the channel data encapsulation packet 516 includes context X and content Y, which corresponds to packets A, B, and C of channel data encapsulation packet 510. After conducting security processing of the channel data encapsulation packet 516, TCP/IP microservice 514 transmits 518 the packet to DPI microservice 520. As shown, the channel data encapsulation packet 522 includes context X and content Y, which corresponds to packets A, B, and C of channel data encapsulation packet 510. After conducting security processing of the channel data encapsulation packet 522, DPI microservice 520 generates channel data encapsulation packet 24, which, as shown, includes context X, DPI load Z, and DPI timestamp T. Encapsulated channel data may be tagged with properties including a timestamp and a load metric. The timestamp may reference the duration of microservice processing, the time at which microservice processing started or another temporal property associated with processing the encapsulated channel data. The load metric may reference the relative or absolute loading of a microservice processing the encapsulated channel data.

As shown, a DPI microservice 520 transmits, via path 526, channel data encapsulation packet 524 to TCP/IP microservice 514, which uses the DPI load and DPI timestamp information to inform future load-balancing decisions. As shown, a TCP/IP microservice 514 generates channel data encapsulation packet 528, which includes context X, TCP/IP load Z, and TCP/IP timestamp T. As shown, TCP/IP microservice 514 transmits, via path 530, channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits the packets to a server 534.

As shown, DPI microservice 520 transmits channel data encapsulation packet 524 to TCP/IP microservice 514, which uses the DPI load and DPI timestamp information to inform future load-balancing decisions. As shown, TCP/IP microservice 514 generates channel data encapsulation packet 528, which includes context X, TCP/IP load Z, and TCP/IP timestamp T. As shown, TCP/IP microservice 514 transmits channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits them to server 534 microservice.

Exemplary benefits of the security service 504 may include the ability of each microservice to utilize the same channel data encapsulation protocol for all communication, thereby allowing scaling across the entirety of the datacenter network routable via the channel data encapsulation header. Communications between microservices maintain a context X generated at interface microservice 508 to all subsequent microservices that no longer have access to the original packets. As an example, a DPI microservice processing content reassembled by a TCP/IP microservice has no visibility into the packets used by the TCP/IP microservice to reassemble the content. However, the context X generated upon reception of one or more of those packets at the interface microservice, forwarded to the TCP/IP microservice and subsequently forwarded by the TCP/IP microservice to the DPI microservice, may be used to determine policy or select a minimal DPI signature set by the DPI microservice without incurring additional state processing. By providing load and timestamp data in the channel data encapsulation packets 524 and 528, which are returned via paths 526 and 530, the microservices receive and can maintain real-time loading and processing latency information utilized to make load balancing decisions.

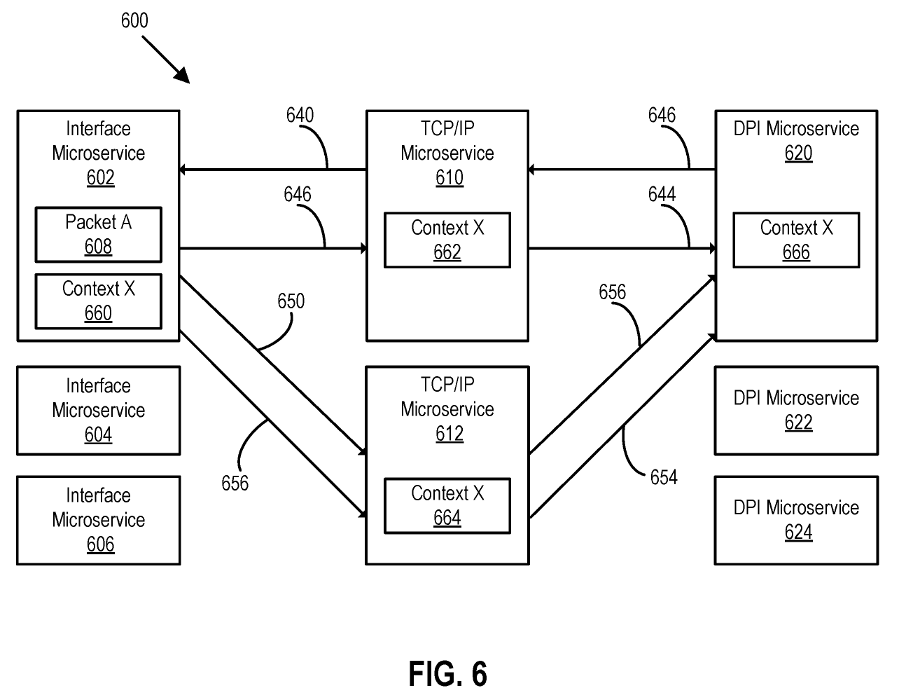

FIG. 6 is a block diagram illustrating a flow of application data through a stateless processing, fault-tolerant microservice environment in accordance with disclosed embodiments. As illustrated, security system 600 includes interface microservices 602, 604, and 606, TCP/IP microservices 610 and 612, and DPI microservices 620, 622, and 624. Other examples include a different number of microservices and/or a different number of microservice types. In the example of FIG. 6, an interface microservice 602 receives packet A 608, and generates a context X 660.

One benefit of the security system illustrated in FIG. 6 is the handling of state. For example, if packets belong to a certain context X, the security system 600 may enable both TCP/IP microservices 610 and 612 to perform meaningful work on the packets. By implementing TCP/IP processing as microservices 610 and 612 with an external state structure and a context that accompanies processed data, each TCP/IP microservice, and any other microservice at every level of the security hierarchy, can be isolated from other microservices and can be scaled independently. Each microservice can access the state for any packet or reassembled packet data, thereby enabling real-time load balancing. In many cases, the context enables microservices to forego consulting service state (state associated with processing at the hierarchy level of the specific microservice), thereby reducing the demands on the global state repository.

As an example, consider the context X 662 obtained by TCP/IP microservice 610 as part of packets received from interface microservice 602 as transmission 646. Context X 662, when transmitted to DPI microservice 620 as part of transmission 644, along with the reassembled packet data, contains information that may enable the DPI microservice to forego or simplify processing of this reassembled data. Such information can include, for example, a context bit or field specifying a subset of regular expressions or patterns to be used for DPI processing, a number of bytes of reassembled data to be received before beginning DPI processing, specific allowed or disallowed protocols, and other information potentially avoiding a DPI state lookup.

In an embodiment, microservices of a security system 600 are stateless. For example, each of the microservices may retrieve state information from an outside source such that the microservice can process packets or content belonging to any context. Each microservice may retrieve and update service state (that state associated with the microservice processing). Additionally, each microservice may retrieve and update context state (state associated with the context relevant for all security service processing). In some embodiments, the process state and context state share a global state service. Examples of elements of context state include a level of suspicion regarding traffic from a source IP, a policy to ignore certain ports or protocols, and other information used to process the packets, reassembled content, and extracted objects from communication identified with the context.

In an embodiment, multiple microservices in the same or different hierarchy of the security system may be able to process packets associated with the same context at the same time. If one security microservice fails (e.g., if a TCP microservice fails to respond to a request), another microservice can take over and process the request using the failed microservice's context.

Returning to FIG. 6, the generation of context X 660 may include considering properties associated with a packet A 608 (e.g., such as an n-tuple detailing routing information), and also a state lookup or a context lookup, in addition to other information. Interface microservice 602 provides packet A 608 and context X 660 to TCP/IP microservice 610 or 612 via path 640 or 650, respectively. For example, interface microservice 602 may conduct a load-balancing to select one of the TCP/IP microservices to forward the packet A 608 and the context X 660.

In an embodiment, TCP/IP microservices 610 and 612 are stateless, but may benefit from the context X generation performed by interface microservice 602. For example, whichever of TCP/IP microservices 610 and 612 receives packet A may disassemble the packet to extract the data associated with the packet and conduct security processing on the data. TCP/IP reassembly generally consists of associating packets with flows (e.g., identified by source and destination IP and port values) and using the TCP sequence numbering to place the packets into a correct order, remove any overlap or duplication, and/or identify missing or out of order packets.

In FIG. 6, TCP/IP microservices 610 or 612 forward the extracted data and/or the data resulting from the security processing to DPI microservice 620 via paths 644 or 656, respectively. Along with the transmitted data, TCP/IP microservice 610 or 612 forwards context X 662 or 664, respectively, to a DPI microservice 620. In some embodiments, context X 660, 662, 664, and 666 are substantially identical.

In an embodiment, DPI microservice 620 is also stateless and may use the context provided by TCP/IP microservice 610 or 612 in transmission 644 or 656. DPI microservice 620 may load DPI processing state before processing the received data, but can perform some work (e.g., scheduling different DPI pattern state tables) based on the context. Transmitting the context to the DPI microservice therefore may obviate some amount of work by the DPI microservice. If TCP/IP microservice 610 fails and interface microservice 602 instead utilizes TCP/IP microservice 612, DPI microservice 620 may obtain the context from the transmission of reassembled TCP content in transmission 656.

Although FIG. 6 does not show a second packet, when a subsequent packet associated with the same context is received, interface microservice 602 may conduct a load balancing and select one of the TCP/IP microservices to forward the packet along with context X 660. In one embodiment, interface microservice 602 chooses to forward the second packet to TCP/IP microservice 612 via path 650. TCP/IP microservice 612 performs some security processing, then transmits the second packet and context X 664 to DPI microservice 620 via path 654. After performing some security processing, DPI microservice 620 responds to TCP/IP microservice 612 via path 654, and TCP/IP microservice responds to interface microservice 602 via path 656.

Summarizing the operation of an embodiment as illustrated by FIG. 6, an interface microservice transmits packets to a TCP/IP microservice along with a context that has been generated based on the contents of the packets. The transmission comprises a request to perform a security service (e.g., TCP/IP reassembly) for the packets to generate reassembled data. The TCP/IP microservice consults the received context to determine whether to obtain a context state, service state, or both, from a state repository to perform the security service. Reassembly is performed by the TCP/IP microservice, any modified state returned to the state repository and the reassembled data transmitted, along with the context, to a DPI microservice as a request to perform DPI processing.

Continuing the example illustrated by FIG. 6, the DPI microservice receives the reassembled data and context from the request to perform DPI security services transmitted by the TCP/IP microservice. The DPI microservice consults the received context to determine whether to obtain a context state, service state, or both, from a state repository to perform its security service. DPI inspection may be performed by the DPI microservice, any modified state returned to the state repository, and a response sent to the TCP/IP microservice.

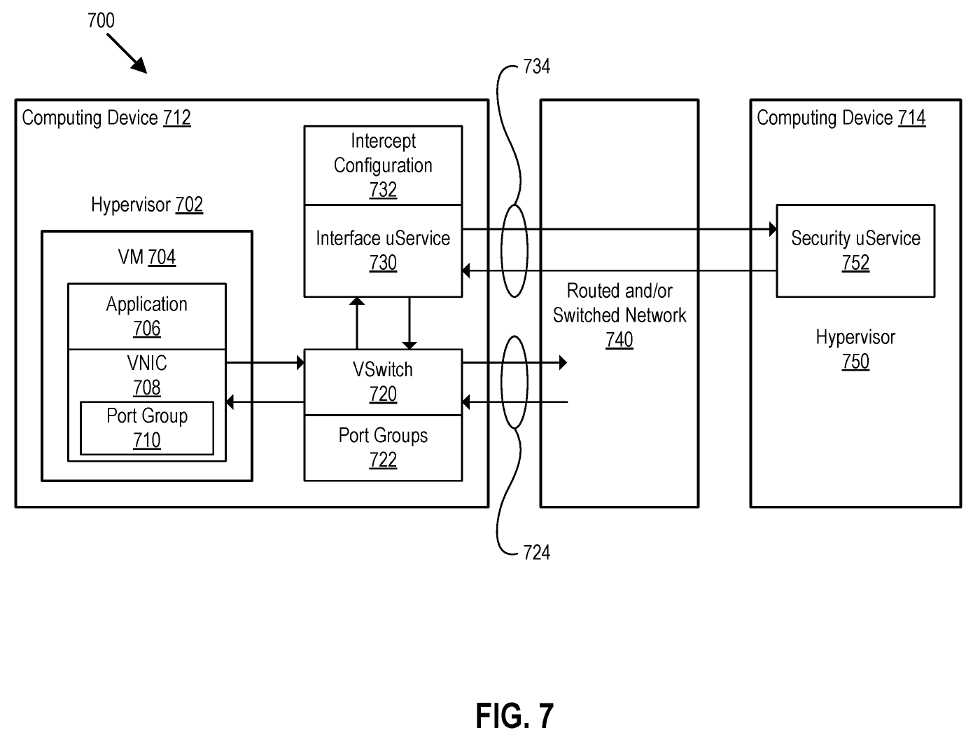

FIG. 7 is a block diagram illustrating an example system for using an interface microservice to intercept network traffic routed by a virtual switch (vSwitch). In one embodiment, system 700 includes at least one computing device 712 coupled to at least one other computing device 714 via routed and/or switched network 740. Routed and/or switched network 740, for example, might be a network within a data center interconnecting various types of devices within the data center, or any other type of network connecting computing devices 712, 714. FIG. 7 represents an example embodiment that is provided for purposes of illustrating a clear example; other embodiments may use different arrangements.

In one embodiment, computing device 712 includes hypervisor 702, vSwitch 720, and interface microservice 730. Hypervisor 702 is a component implemented in software, hardware, firmware, or combinations thereof, and which manages the creation and operation of one or more virtual machines (VMs) (e.g., VM 704). Examples of hypervisor 702 include, but are not limited to, a VMware® ESX™/ESXi™ hypervisor, a Citrix® XenServer® hypervisor, or a Microsoft® Hyper-V® hypervisor. In some embodiments, vSwitch 720 and port groups 722 are integrated into or otherwise part of hypervisor 702, configured via hypervisor 702, or some combination thereof.

In one embodiment, VM 704 running on hypervisor 702 is generally any type of emulated computer system that can share hardware resources with one or more other VMs running on hypervisor 702. In the example of FIG. 7, VM 704 includes at least one application 706 and at least one virtual network interface card (VNIC) 708. Examples of application 706 include, but are not limited to, an operating system, a system application, and a user application.

In one embodiment, VM 704 is one of a plurality of VMs networked as part of a virtual network. The plurality of VMs can be networked in part using one or more vSwitches (e.g., vSwitch 720). Whereas a physical Ethernet switch manages network traffic between machines on a physical network, a vSwitch manages network traffic between VMs logically connected to virtual ports of the vSwitch. A vSwitch can be connected to other vSwitches and to one or more physical switches (not shown in FIG. 7) using physical Ethernet adapters to join virtual networks with physical networks. For example, network path 724 might connect vSwitch 720 to a routed and/or switched network 740 via one or more physical switches.

In one embodiment, VNIC 708 of VM 704 is connected to a port of vSwitch 720, and the port can be assigned to port group 710. At a high level, a port group is a vSwitch configuration which defines a logical grouping of VNICs connected to the ports comprising the group. For example, system 700 might include any number of VMs 704 having any number of VNICs 708, and the VNICs can be grouped into any number of port groups by the vSwitch 720. A port group can be further associated with configuration options applied to the member ports including, for example, bandwidth limitations, traffic shaping rules, and other settings. In one embodiment, vSwitch 720 stores configuration information related to port groups as port groups configuration 722. Based on the port groups configuration 722, for example, when vSwitch 720 receives a packet from a VNIC of a VM, vSwitch 720 can determine which port group the VNIC is associated with and tag the packet with a VLAN assigned to the port group in the configuration.

In one embodiment, interface microservice 730 enables network traffic sent to and received from VM 704 (and any other VMs generating network traffic routed by vSwitch 720) to be intercepted and filtered based on intercept configuration 732. As shown in FIG. 7, interface microservice 730 can optionally send, via network path 734, intercepted network traffic to security microservice 752 running on separate computing device 714. The computing device 714, for example, includes separate hypervisor 750 and may further include any number of VMs running on hypervisor 750. In other examples, interface microservice 730 can perform various security operations locally at computing device 712 without sending the intercepted network traffic to a separate computing device 714.

In one embodiment, a microservice as depicted in FIG. 7 (e.g., interface microservice 730 or security microservice 752) is implemented using a software “container,” where a container is an isolated user space instance within a virtualization environment in which the kernel of an operating system allows for the existence of multiple isolated user-space instances. In other examples, a microservice is implemented by a virtual machine instance, a thread of execution, a standalone software application, or any other type of computer-executable logic.

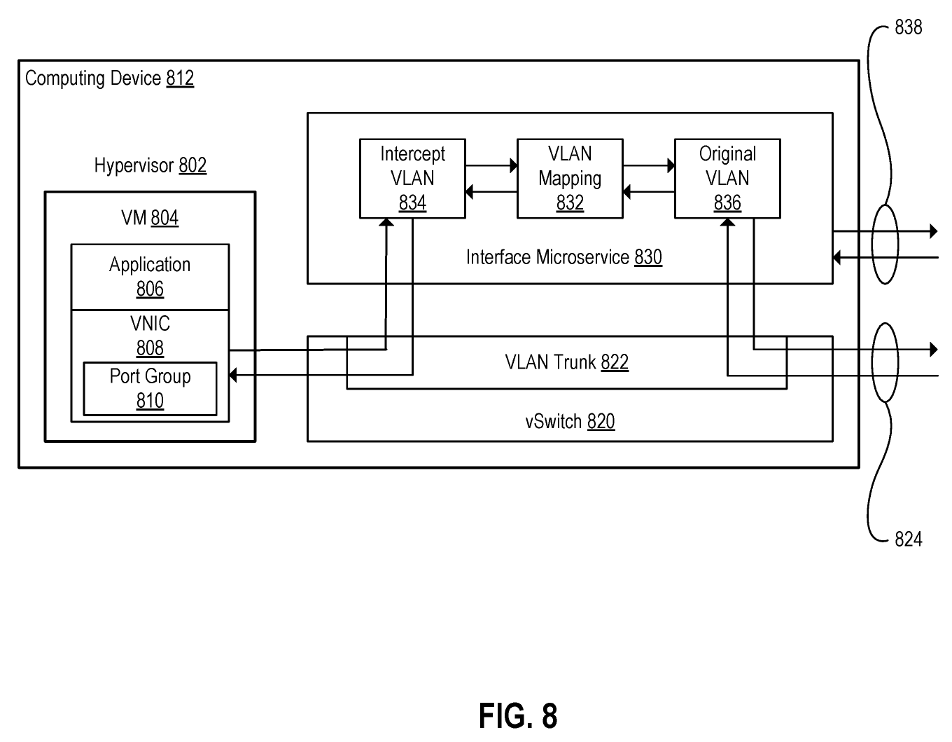

FIG. 8 is a block diagram illustrating an example interface microservice configured to intercept network traffic routed by a vSwitch in accordance with the disclosed embodiments. In FIG. 8, for example, interface microservice 830 on computing device 812 intercepts network traffic routed by vSwitch 820 (e.g., network traffic sent and received by VM 804 via VNIC 808). When VNIC 808 sends a network packet (e.g., based on a request generated by application 806 or another source), VM 804 includes an identifier associated with port group 810 with the network packet. In embodiments where interface microservice 830 is not present in FIG. 8, the network packets including port group identifier arrive at vSwitch 820, vSwitch 820 determines a VLAN to which port group 810 is assigned, and sends the network packet out network path 824 based on the determined VLAN.

In the embodiment of FIG. 8, a VLAN assigned to port group 810 as in the example above is referred to as an “original” or “existing” VLAN. In one embodiment, to enable interface microservice 830 to intercept network traffic routed by vSwitch 820, interface microservice 830 (or another configuration microservice) creates a new VLAN, referred to herein as an “intercept” VLAN, for each original VLAN and further generates and stores VLAN mapping 832 indicating a mapping from each original VLAN to a respective intercept VLAN. Interface microservice 830 further adds the original VLAN and the intercept VLAN to VLAN trunk 822 enabling the traffic on both VLANs to be routed to an interface microservice 830.

In one embodiment, based on the configuration described above, interface microservice 830 can change the VLAN assigned to port group 810 of VM 804 from the original VLAN to the intercept VLAN and, consequently, packets sent from VM 804 are directed to interface microservice 830 via the VLAN trunk 822. The interface microservice 830 can then translate the intercept VLAN 834 to the original VLAN 836 using the VLAN mapping 832, and network traffic leaving network path 824 can be associated with the original VLAN.

Similarly, when a network packet is received by vSwitch 820 coming in from network path 824, because interface microservice 830 is now part of VLAN trunk 822 for both the intercept VLAN and the original VLAN and the incoming network packets are associated with the original VLAN, the network packets are routed to interface microservice 830. Interface microservice 830 similarly maps the original VLAN to the intercept VLAN using VLAN mapping 832, and the packets are sent to VM 804 using VLAN trunk 822. In this manner, the changes to the network structure at hypervisor 802 and vSwitch 820 are transparent to outside devices which only are aware of the original VLAN.

In one embodiment, interface microservice 830 determines whether a network packet (or multiple network packets) require further inspection (e.g., via a security microservice) prior to allowing the network packet to proceed to its destination. In one embodiment, when a network packet requires inspection, interface microservice 830 transmits the network packet on network path 838 to another computing device for processing by a security microservice. In other embodiments, when a network packet requires inspection, the network packet is not transmitted and a local security microservice performs the inspection. In one embodiment, interface microservice 830 prevents the network packet from being transmitted to the intended destination of the network packet prior to completion of the inspection. In other embodiments, interface microservice 830 performs the inspection concurrently with transmitting the network packet to the intended destination. In such embodiments, interface microservice 830 generates a copy of the network packet to perform the inspection.

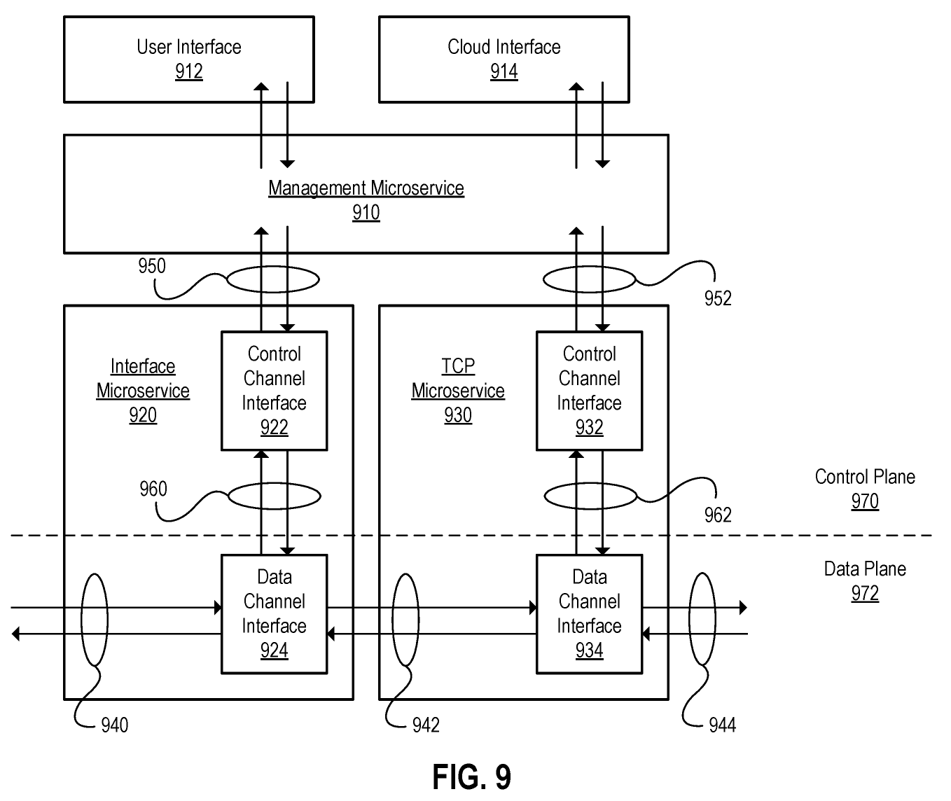

FIG. 9 is a block diagram illustrating an example system for using security microservices (e.g., microservices 108-122 in FIG. 1) to intercept and inspect network traffic in accordance with the disclosed embodiments. FIG. 9 includes security microservices (e.g., interface microservice 920 and TCP microservice 930). In FIG. 9, management microservice 910 manages the security microservices (e.g., 920 and 930). In one embodiment, management microservice 910 spawns and configures the security microservices, controls the policies associated with the security microservices used to determine what network traffic to analyzes, receives inputs from user interface 912 and cloud interface 914, including modifications and updates to policies and signatures. For example, management microservice 910 receives a security policy to apply to the network traffic via one or both of user interface 912 and cloud interface 914. In one embodiment, management microservice 910 manages the security microservices via management network interfaces 950 and 952 to interface microservice 920 and TCP microservice 930, respectively. In one embodiment, additional security microservices are included in the system of FIG. 9. For example, in some embodiments, TCP microservice 930 forwards network traffic on network path 944 to a DPI microservice, an SSL microservice, or another security microservice. In such embodiments, management microservice 910 performs similar functions with any additional security microservices.

In one embodiment, interface microservices 920 processes network traffic (e.g., network packets) to determine whether to sequester network traffic for additional inspection and how to route the network traffic, and TCP microservice 930 performs TCP reassembly. In one embodiment, TCP microservice 930 receives network traffic inspected by interface microservice 920, while network traffic that is not inspected by interface microservice 920 is not inspected by TCP microservice. For example, interface microservice 920 receives network traffic on network path 940. When interface microservice 920 determines that the network traffic requires inspection, interface microservice 920 sends the network traffic over network path 942 to TCP microservice 930. When interface microservice 920 determines that the network traffic does not require inspection, interface microservice 920 sends the network traffic back over network path 940, e.g., back to a vSwitch for transmission to the intended destination of the network traffic.

In one embodiment, interface microservice 920 includes control channel interface 922 and data channel interface 924 that operate within control plane 970 and data plane 972, respectively. In one embodiment, control plane 970 is the portion of the microservice response for analysis, policy, and management functions. In one embodiment, data plane 972 is the portion of the microservice responsible for handling the receipt of network traffic (e.g., data packets) across network paths (e.g., 940 and 944) and communications. In some embodiments, however, some data from network path 940 is passed to the control plane. For example, a packet triggering a security policy will commonly be passed to control plane 970 for the purpose of generating an alert within management microservice 910 and displaying some portion of the original packet data. In one embodiment, data plane 972 deals with the network path 940 that is being protected by the security service (e.g., 124) whereas control plane 970 deals with the administrative and functional aspects of providing said security service.

Similarly, TCP microservice 930 includes control channel interface 932 and data channel interface 934 that interact with control planet 980 and data plane 972, respectively. Control plane 970 traffic is the data and signals sent between security microservices 920, 930 and management microservice 910, via control channel interface 922 and control channel interface 932, respectively. In one embodiment, control channel interface 922 and control channel interface 932 are management interfaces that facilitate communications between management microservice 910 and security microservices 920, 930. Examples of control plane 970 signals from management microservice 910 to security microservices 920, 930 include packets instructing the security microservice 920, 930 to enable interface or TCP processing on a server, or packets instructing the security microservice to apply new or modified policies to network traffic. Data plane 972 traffic includes packets associated with VMs that are under security management. Examples of data plane 972 signals includes data (e.g., network traffic) broadcast by a VM that is passed between data channel interfaces 924, 934 of security microservices 920, 930.

While management microservice 910 can respond to the demands of the system by spawning and initializing addition security microservices dynamically, this presents the potential for bad or malicious network traffic to reach microservices that can have negative impacts. For example, when TCP microservice 930 is initialized, TCP microservice 930 communicates with management microservice 910 across management network interface 952. While TCP microservice 930 is initializing malicious network traffic may enter TCP microservice 930 across network path 942 and/or network path 944, and has the potential to reach management microservice 910 by traversing from data channel interface 934 to control channel interface 932 across network path 962, and subsequently to management microservice 910 across management network interface 952. In one embodiment, the malicious network traffic reaches management microservice 910 when control channel interface 932 and data channel interface 934 are not synchronized or are in different states of operation.

It will be understood by those of ordinary skill in the art that the network paths 960 and 962 may be paths such as sockets transmitting packets, shared memory or other means of transmitting data between a data channel interface to a control channel interface. In some implementations, the data need not be moved to be transmitted as it is sufficient to pass a pointer to the data from one interface to the other or from one control element to another.

In one embodiment, management network interface 952 is a secure interface. In one embodiment, management network interface 952 is a certificate-based interface. When management microservice 910 spawns or initializes TCP microservice 930, management microservice 910 prevents TCP microservice 930 from automatically sending data across management network interface 952.

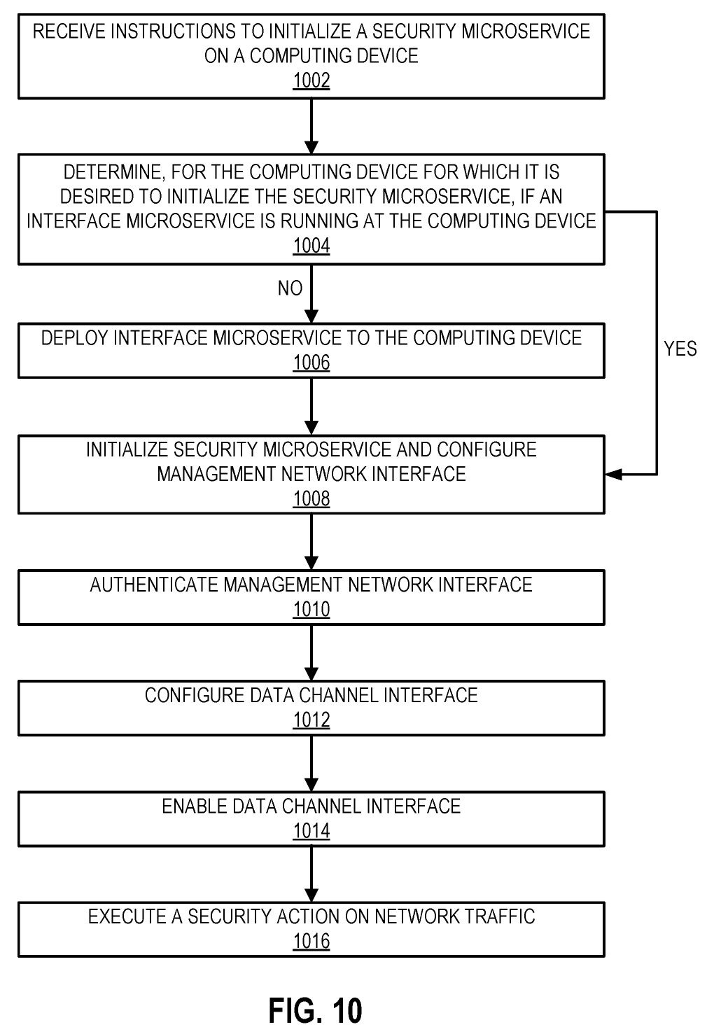

FIG. 10 is a flow diagram illustrating a process for initializing security microservices in a computing device in accordance with an embodiment. For ease of understanding, the description of FIG. 10 below references components of the networked environments of FIGS. 1, 7, and 9, however, it is not limited to those components. The method described in FIG. 10 initializes a security microservice on a computing device (e.g., a server) in a secure manner. Such embodiments efficiently prevent bad or malicious network traffic from reaching trusted areas of a control plane (e.g., control plane 970) or management components (e.g., management microservice 910) through the below described initialization and authentication process. For example, the embodiments described herein protect trusted areas from malicious network traffic passing between security microservices in a data plane (e.g., data plane 972). In one embodiment, the actions below are performed using a security service (e.g., 124 in FIG. 1). In one embodiment, security service 124 encompasses, at least, management microservice 910, interface microservice 920, and TCP microservice 930. In another embodiment, management microservice 910 receives instructions to perform the actions described below. Further, the actions below may be performed by one or more security microservices and/or one or more interface microservices at the direction of management microservice 910. As such, a single security microservice may perform an action, or two more security services may perform the action either independently, or in conjunction. Although FIG. 10 describes operations performed by a management microservice (e.g., management microservice 910), some or all of the operations described in FIG. 10 can be performed by a configuration microservice, an interface microservice, another type of microservice, an application, or any other computer-executable logic.

At block 1002, management microservice 910 receives instructions, or a request message, to initialize a security microservice on the computing device. In one embodiment, management microservice 910 receives the instructions via user interface 912 or cloud interface 914. In one embodiment, the request is responsive to detection of high processing, memory or storage load on existing microservices, responsive to detection of new virtual or physical servers within the secure environment or new communications paths to or from virtual or physical servers within the secure environment, responsive to user or administrator requests for the initialization of additional microservices, or responsive to changes in security policy within the secure environment or other causes related to the security environment.

At block 1004, management microservice 910 determines, for the computing device (e.g., computing device 714 in FIG. 7) for which it is desired to intercept and filter network traffic and initialize one or more security microservices, if an interface microservice (e.g., interface microservice 920) is running on computing device 714. As described with respect to FIG. 10, computing device 714 is a separate computing device or server from a computing device (e.g., 712) that is the source and/or destination of network traffic. In other embodiments, computing device 714 is the source and/or destination of network traffic. In one embodiment, computing device 712, for which it is desired to intercept and filter network traffic includes at least one hypervisor, and at least one VM is running on the at least one hypervisor. As illustrated in FIG. 7, for example, computing device 712 includes at least one hypervisor 702, where at least one VM (e.g., VM 704) is running on the hypervisor. In one embodiment, VM 704 includes VNIC 708 that is connected to a port of virtual distributed switch (vSwitch 720), which routes network traffic over routed and/or switched network 740 via network path 724. If interface microservice 920 is not currently running on computing device 714, the method proceeds to block 1006. Otherwise, if interface microservice 920 is currently running on computing device 714, the method proceeds to block 1008. In one embodiment, management microservice 910 deploys a new interface microservice, by proceeding to block 1006. In one embodiment, management microservice 910 deploys a new interface microservice even when one or more existing interfaces microservices are currently running on computing device 714. For example, one or more new interface microservices may be deployed if the existing interface microservices are experiencing heavy load, are reserved or partitioned for exclusive use portions of network traffic analysis, or there is some performance benefit or management advantage to be obtained by deploying additional interface microservices.

At block 1006, if interface microservice 920 is not currently running on computing device 714, management microservice 910 deploys or initializes interface microservice 920 on computing device 714.

At block 1008, management microservice 910 initializes the requested security microservice (e.g., TCP microservice 930 in FIG. 9) and configures management network interface 952. In one embodiment, when management microservice 910 initializes TCP microservice 930, management microservice 910 starts control channel interface 932. In addition, management microservice 910 sends data instructing or directing TCP microservice 930 to authenticate management network interface 952 using control channel interface 932.

In one embodiment, management microservice 910 initializes other microservices and provides a token or secure datum (such as a key, passphrase or other authentication element) which is passed by the other microservice to management microservice 910 during authentication. In one embodiment, such tokens or security data are single-use entities such that only a single authentication action can be performed using said tokens or security data. In one embodiments, such tokens or security data comprise identity information signed using the private key of management microservice 910.

At block 1010, management microservice 910 authenticates management network interface 952. In one embodiment, management microservice 910 provides an authentication key to TCP microservice 930 to perform the authentication when TCP microservice 930 is spawned/initialized. In such embodiments, as part of the authentication process, TCP microservice 930 sends the authentication key to management microservice 910 using control channel interface 932. In other embodiments, management microservice 910 performs the authentication using a certificate-based authentication, token-based authentication, using a pointer to a certificate or token, or other authentication methods, as would be understood by one of ordinary skill in the art. Alternatively, the management interface may utilize a certificate or other cryptographic data to perform a key exchange with management microservice 910.

At block 1012, management microservice 910 configures data channel interface 934 by directing TCP microservice 930 to enable and configure the data channel interface responsive to the authentication of the control channel interface at block 1008. In one embodiment, management microservice 910 configures data channel interface 934 in TCP microservice 930 only after determining that management network interface 952 has been authenticated between management microservice 910 and TCP microservice 930.

At block 1014, management microservice 910 enables data channel interface 934. In one embodiment, management microservice 910 enables data channel interface 934 subsequent and in response to management network interface 952 being authenticated. Once enabled, data channel interface 934 is operable to receive network traffic from data channel interface 924 in interface microservice 920 on network path 942, and/or from one or more other security microservices (not shown) on network path 944.

In one embodiment, prior to enabling data channel interface 934, TCP microservice 930 does not have an active interface with interface microservice 920 and/or from other configured security microservices. When TCP microservice 930 does not have an active interface with interface microservice 920 and/or from other configured security microservices, TCP microservice 930 is prevented from receiving network traffic from interface microservice 920 and/or from other configured security microservices. In such embodiments, enabling data channel interface 934 after management network interface 952 is authenticated prevents malicious network traffic from being able to reach management microservice 910 during the security microservice initialization process.

At block 1016, management microservice 910 executes security actions on network traffic. In some embodiments, executing the security action includes performing one or more of: blocking network traffic on the connection, quarantining the network traffic, and transmitting an alert message. In one embodiment, management microservice 910 receives a security policy to apply to the network traffic via an interface (e.g., user interface 912 and cloud interface 914). In one embodiment, management microservice 910 applies the security policy to the network traffic. In other embodiments, management microservice 910 directs TCP microservice 930 to apply the security policy by sending instructions to TCP microservice 930 on management network interface 952.

According to one embodiment, the techniques described herein are implemented by one or more special-purpose computing devices. The special-purpose computing devices may be desktop computer systems, portable computer systems, handheld devices, networking devices or any other device that incorporates hard-wired, program logic, or both to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

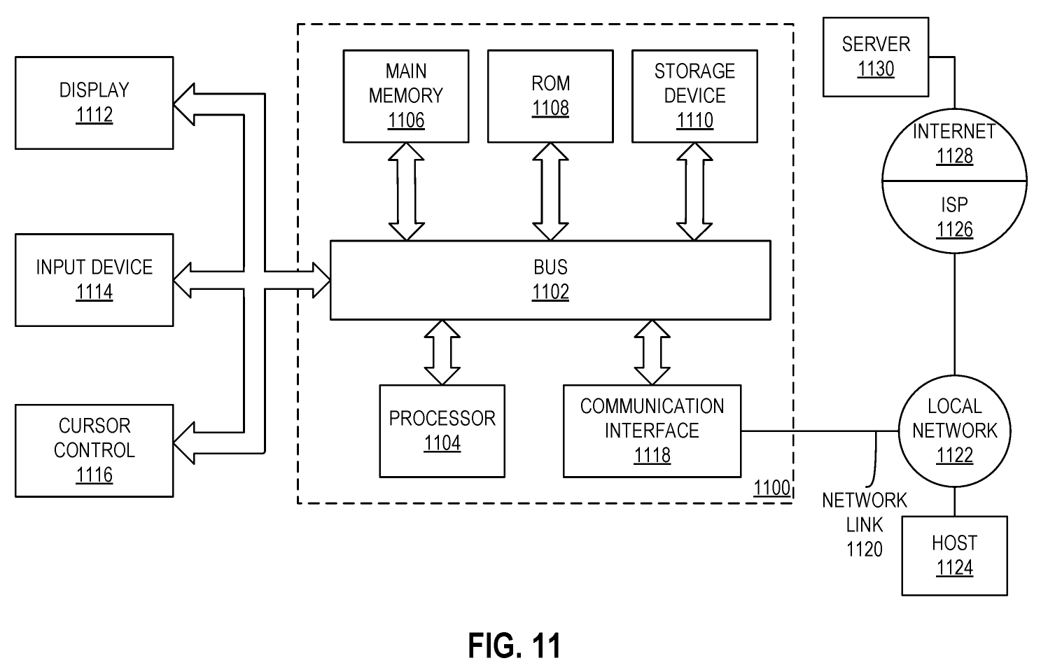

FIG. 11 is a block diagram that illustrates a computer system 1100 utilized in implementing the above-described techniques in accordance with some of the disclosed embodiments. Computer system 1100 may be, for example, a desktop computing device, laptop computing device, tablet, smartphone, server appliance, computing mainframe, multimedia device, handheld device, networking apparatus, or any other suitable device.

Computer system 1100 includes one or more buses 1102 or other communication mechanism for communicating information, and one or more hardware processors 1104 coupled with buses 1102 for processing information. Hardware processors 1104 may be, for example, general purpose microprocessors. Buses 1102 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1100 also includes a main memory 1106, such as a random access memory (RAM) or other dynamic or volatile storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 a special-purpose machine that is customized to perform the operations specified in the instructions.

Computer system 1100 further includes one or more read only memories (ROM) 1108 or other static storage devices coupled to bus 1102 for storing static information and instructions for processor 1104. One or more storage devices 1110, such as a solid-state drive (SSD), magnetic disk, optical disk, or other suitable non-volatile storage device, is provided and coupled to bus 1102 for storing information and instructions.

Computer system 1100 may be coupled via bus 1102 to one or more displays 1112 for presenting information to a computer user. For instance, computer system 1100 may be connected via a High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1112 may include, without limitation, plasma display devices, projectors, cathode ray tube (CRT) monitors, electronic paper, virtual reality headsets, braille terminal, and/or any other suitable device for outputting information to a computer user. In one embodiment, any suitable type of output device, such as, for instance, an audio speaker or printer, may be utilized instead of a display 1112.

One or more input devices 1114 are coupled to bus 1102 for communicating information and command selections to processor 1104. One example of an input device 1114 is a keyboard, including alphanumeric and other keys. Another type of user input device 1114 is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane. Yet other examples of suitable input devices 1114 include a touch-screen panel affixed to a display 1112, cameras, microphones, accelerometers, motion detectors, and/or other sensors. In one embodiment, a network-based input device 1114 may be utilized. In such an embodiment, user input and/or other information or commands may be relayed via routers and/or switches on a Local Area Network (LAN) or other suitable shared network, or via a peer-to-peer network, from the input device 1114 to a network link 1120 on the computer system 1100.

A computer system 1100 may implement techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1110. Volatile media includes dynamic memory, such as main memory 1106. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or a solid state drive of a remote computer. The remote computer can load the instructions into its dynamic memory and use a modem to send the instructions over a network, such as a cable network or cellular network, as modulate signals. A modem local to computer system 1100 can receive the data on the network and demodulate the signal to decode the transmitted instructions. Appropriate circuitry can then place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

A computer system 1100 may also include, In one embodiment, one or more communication interfaces 1118 coupled to bus 1102. A communication interface 1118 provides a data communication coupling, typically two-way, to a network link 1120 that is connected to a local network 1122. For example, a communication interface 1118 may be an integrated services digital network (ISDN) card, cable modem, satellite modem, or a modem to provide a data communication connection to a corresponding type of telephone line. As another example, the one or more communication interfaces 1118 may include a local area network (LAN) card to provide a data communication connection to a compatible LAN. As yet another example, the one or more communication interfaces 1118 may include a wireless network interface controller, such as an 802.11-based controller, Bluetooth controller, Long Term Evolution (LTE) modem, and/or other types of wireless interfaces. In any such implementation, communication interface 1118 sends and receives electrical, electromagnetic, or optical signals that carry digital data streams representing various types of information.

Network link 1120 typically provides data communication through one or more networks to other data devices. For example, network link 1120 may provide a connection through local network 1122 to a host computer 1124 or to data equipment operated by a Service Provider 1126. Service Provider 1126, which may for example be an Internet Service Provider (ISP), in turn provides data communication services through a wide area network, such as the world wide packet data communication network now commonly referred to as the “Internet” 1128. Local network 1122 and Internet 1128 both use electrical, electromagnetic or optical signals that carry digital data streams. The signals through the various networks and the signals on network link 1120 and through communication interface 1118, which carry the digital data to and from computer system 1100, are example forms of transmission media.

In one embodiment, computer system 1100 can send messages and receive data, including program code and/or other types of instructions, through the network(s), network link 1120, and communication interface 1118. In the Internet example, a server 1130 might transmit a requested code for an application program through Internet 1128, ISP 1126, local network 1122 and communication interface 1118. The received code may be executed by processor 1104 as it is received, and/or stored in storage device 1110, or other non-volatile storage for later execution. As another example, information received via a network link 1120 may be interpreted and/or processed by a software component of the computer system 1100, such as a web browser, application, or server, which in turn issues instructions based thereon to a processor 1104, possibly via an operating system and/or other intermediate layers of software components.

In one embodiment, some or all of the systems described herein may be or comprise server computer systems, including one or more computer systems 1100 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In one embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In one embodiment, the cloud-based components may be implemented by third-party entities, on behalf of another entity for whom the components are deployed. In other embodiments, however, the described systems may be implemented entirely by computer systems owned and operated by a single entity.

In one embodiment, an apparatus comprises a processor and is configured to perform any of the foregoing methods. In one embodiment, a non-transitory computer-readable storage medium, storing software instructions, which when executed by one or more processors cause performance of any of the foregoing methods.

Although some embodiments disclosed herein involve data handling and distribution in the context of hardware execution units and logic circuits, other embodiments can be accomplished by way of a data or instructions stored on a non-transitory machine-readable, tangible medium, which, when performed by a machine, cause the machine to perform functions consistent with at least one embodiment. In one embodiment, functions associated with embodiments of the present disclosure are embodied in computer-executable instructions. The instructions can be used to cause a general-purpose or special-purpose hardware processor that is programmed with the instructions to perform the steps of the at least one embodiment. Embodiments of the present invention may be provided as a computer program product or software which may include a machine or computer-readable medium having stored thereon instructions which may be used to program a computer (or other electronic devices) to perform one or more operations according to the at least one embodiment. Alternatively, steps of embodiments may be performed by specific hardware components that contain fixed-function logic for performing the steps, or by any combination of programmed computer components and fixed-function hardware components.

Instructions used to program circuits to perform at least one embodiment can be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Examples of embodiments of methods, apparatuses, systems, etc. detailed herein are listed below.

In some embodiments, a computer-implemented method comprises: receiving instructions to initialize a security microservice on a computing device; initializing the security microservice on the computing device; configuring a management network interface as a secure channel with the security microservice; authenticating the management network interface; enabling a data channel interface for the security microservice responsive to authenticating the management network interface, the data channel interface for receiving network traffic from one or more of a plurality of security microservices; and executing a security action on the network traffic received at the enabled data channel interface.

In some embodiments, one or more of the following applies: 1) the security microservice is prevented from receiving network traffic prior to enabling the data channel interface for the security microservice; 2) the method further comprises: determining whether an interface microservice is running on the computing device; and deploying the interface microservice on the computing device when the interface microservice is not running on the computing device; 3) the network traffic is received at the enabled data channel interface of the security microservice from one of the interface microservice and one of the plurality of security microservices; 4) the management network interface operates in a control plane, and wherein the data channel interface operates in a data plane; and 5) the method further comprises: receiving a security policy to apply to the network traffic via one or more interfaces.

In some embodiments, one or more non-transitory computer-readable storage media store instructions which, when executed by one or more hardware processors, cause performance of a method comprising: receiving instructions to initialize a security microservice on a computing device; initializing the security microservice on the computing device; configuring a management network interface as a secure channel with the security microservice; authenticating the management network interface; enabling a data channel interface for the security microservice responsive to authenticating the management network interface, the data channel interface for receiving network traffic from one or more of a plurality of security microservices; and executing a security action on the network traffic received at the enabled data channel interface.

In some embodiments, one or more of the following applies: 1) the security microservice is prevented from receiving network traffic prior to enabling the data channel interface for the security microservice; 2) the method further comprises: determining whether an interface microservice is running on the computing device; and deploying the interface microservice on the computing device when the interface microservice is not running on the computing device; 3) the network traffic is received at the enabled data channel interface of the security microservice from one of the interface microservice and one of the plurality of security microservices; 4) the management network interface operates in a control plane, and wherein the data channel interface operates in a data plane; and 5) the method further comprises: receiving a security policy to apply to the network traffic via one or more interfaces.

In some embodiments, an apparatus comprises: one or more hardware processors; and memory coupled to the one or more hardware processors, the memory storing instructions which, when executed by the one or more hardware processors, cause the apparatus to: receive instructions to initialize a security microservice on a computing device; initialize the security microservice on the computing device; configure a management network interface as a secure channel with the security microservice; authenticate the management network interface; enable a data channel interface for the security microservice responsive to authenticating the management network interface, the data channel interface for receiving network traffic from one or more of a plurality of security microservices; and execute a security action on the network traffic received at the enabled data channel interface.

In some embodiments, one or more of the following applies: 1) the security microservice is prevented from receiving network traffic prior to enabling the data channel interface for the security microservice; 2) the instructions further cause the apparatus to: determine whether an interface microservice is running on the computing device, and deploy the interface microservice on the computing device when the interface microservice is not running on the computing device; 3) the network traffic is received at the enabled data channel interface of the security microservice from one of the interface microservice and one of the plurality of security microservices; 4) the management network interface operates in a control plane, and wherein the data channel interface operates in a data plane; and 5) the instructions further cause the apparatus to: receive a security policy to apply to the network traffic via one or more interfaces.

What is claimed is:

1. A computer-implemented method comprising:
receiving instructions to initialize a security microservice on a computing device;
initializing the security microservice on the computing device;
configuring a management network interface as a secure channel with the security microservice;
authenticating the management network interface;
enabling a data channel interface for the security microservice responsive to authenticating the management network interface, the data channel interface for receiving network traffic from one or more of a plurality of security microservices; and
executing a security action on the network traffic received at the enabled data channel interface.

2. The computer-implemented method of claim 1, wherein the security microservice is prevented from receiving the network traffic prior to enabling the data channel interface for the security microservice.

3. The computer-implemented method of claim 1, further comprising:
determining whether an interface microservice is running on the computing device; and
deploying the interface microservice on the computing device when the interface microservice is not running on the computing device.

4. The computer-implemented method of claim 1, wherein the network traffic is received at the enabled data channel interface of the security microservice from one of the interface microservice and one of the plurality of security microservices.

5. The computer-implemented method of claim 1, wherein the management network interface operates in a control plane, and wherein the data channel interface operates in a data plane.

6. The computer-implemented method of claim 1, further comprising:
receiving a security policy to apply to the network traffic via one or more interfaces.

7. One or more non-transitory computer-readable storage media storing instructions which, when executed by one or more hardware processors, cause performance of a method comprising:
receiving instructions to initialize a security microservice on a computing device;
initializing the security microservice on the computing device;
configuring a management network interface as a secure channel with the security microservice;
authenticating the management network interface;
enabling a data channel interface for the security microservice responsive to authenticating the management network interface, the data channel interface for receiving network traffic from one or more of a plurality of security microservices; and
executing a security action on the network traffic received at the enabled data channel interface.

8. The one or more non-transitory computer-readable storage media of claim 7, wherein the security microservice is prevented from receiving the network traffic prior to enabling the data channel interface for the security microservice.

9. The one or more non-transitory computer-readable storage media of claim 7, further comprising:
determining whether an interface microservice is running on the computing device; and
deploying the interface microservice on the computing device when the interface microservice is not running on the computing device.

10. The one or more non-transitory computer-readable storage media of claim 7, wherein the network traffic is received at the enabled data channel interface of the security microservice from one of the interface microservice and one of the plurality of security microservices.

11. The one or more non-transitory computer-readable storage media of claim 7, wherein the management network interface operates in a control plane, and wherein the data channel interface operates in a data plane.

12. The one or more non-transitory computer-readable storage media of claim 7, further comprising:
receiving a security policy to apply to the network traffic via one or more interfaces.

13. An apparatus comprising:
one or more hardware processors;
memory coupled to the one or more hardware processors, the memory storing instructions which, when executed by the one or more hardware processors, causes the apparatus to:
receive instructions to initialize a security microservice on a computing device;
initialize the security microservice on the computing device;
configure a management network interface as a secure channel with the security microservice;
authenticate the management network interface;
enable a data channel interface for the security microservice responsive to authenticating the management network interface, the data channel interface for receiving network traffic from one or more of a plurality of security microservices; and
execute a security action on the network traffic received at the enabled data channel interface.

14. The apparatus of claim 13, wherein the security microservice is prevented from receiving the network traffic prior to enabling the data channel interface for the security microservice.

15. The apparatus of claim 13, wherein the instructions further cause the apparatus to:
determine whether an interface microservice is running on the computing device; and
deploy the interface microservice on the computing device when the interface microservice is not running on the computing device.

16. The apparatus of claim 13, wherein the network traffic is received at the enabled data channel interface of the security microservice from one of the interface microservice and one of the plurality of security microservices.

17. The apparatus of claim 13, wherein the management network interface operates in a control plane, and wherein the data channel interface operates in a data plane.

18. The apparatus of claim 13, wherein the instructions further cause the apparatus to:
receive a security policy to apply to the network traffic via one or more interfaces.
